(19) United States
(12) Patent Application Publication
(10) Pub. No.: US 2023/0307617 A1
(43) Pub. Date: Sep. 28, 2023

(54) POSITIVE ELECTRODE COMPOSITIONS AND ARCHITECTURES FOR AQUEOUS RECHARGEABLE ZINC BATTERIES, AND AQUEOUS RECHARGEABLE ZINC BATTERIES USING THE SAME

(71) Applicant: Salient Energy Inc., Dartmouth (CA)

(72) Inventors: Brian D. Adams, Dartmouth (CA); Marine B. Cuisinier, Dartmouth (CA); Susi Jin, Richmond Hill (CA); John Philip S. Lee, Dartmouth (CA); Jason Quinn, Waverley (CA); John Tytus, Orillia (CA); Yukun Wang, Dartmouth (CA); Haonan Yu, Halifax (CA)

(21) Appl. No.: 18/011,402

(22) PCT Filed: Jun. 17, 2021
(86) PCT No.: PCT/CA2021/050832

§ 371 Date: Dec. 19, 2022

Related U.S. Application Data
(60) Provisional application No. 63/040,478, filed on Jun. 17, 2020.

(51) Int. Cl. H01M 4/38; H01M 4/04; H01M 4/62; H01M 10/36

(52) U.S. Cl. CPC H01M 4/38; H01M 4/0404; H01M 4/625; H01M 10/36; H01M 2004/027

(57) ABSTRACT

Provided are rechargeable batteries, positive electrodes, and methods for manufacturing rechargeable batteries and positive electrodes. A rechargeable battery as disclosed includes a zinc metal negative electrode, an electrolyte having a pH between ˜4 and ˜6, and a positive electrode. The positive electrode includes a current collector and a primer coating layer applied to the current collector to form a primer-coated current collector for protecting the current collector from the electrolyte. The primer coating layer includes a binder and a conductive filler. The positive electrode further includes a positive electrode composite layer applied to the primer coating layer. The positive electrode composite layer includes a hydrophilic binder, a conductive additive, and a material that undergoes reversible faradaic reactions with zinc ions.

### TECHNICAL FIELD

The following relates generally to electrochemical cells (hereafter, cells or batteries) that use water as the electrolyte solvent, and more specifically to positive electrode compositions and architectures for aqueous rechargeable zinc batteries.

### Introduction

The present disclosure relates generally to improving the performance of rechargeable electrochemical cells in a mild (pH ˜4 to ˜6) aqueous electrolyte, more particularly but not limited to cells with zinc metal negative electrodes (hereinafter, zinc cells or batteries). The terms cell/battery and cells/batteries are used interchangeably throughout this disclosure.

Metallic zinc negative electrodes are used in many primary (non-rechargeable) and secondary (rechargeable) aqueous battery types. Zinc is inexpensive, non-toxic, has a low redox potential (−0.76 V vs. standard hydrogen electrode) compared to other negative electrode materials used in aqueous batteries, and is stable in water due to a high overpotential for hydrogen evolution.

Electrochemical cells employing zinc metal have been used in commercial applications for well over a century. Of all traditional and modern types of batteries using zinc metal electrodes, only the alkaline (Zn∥MnO₂), zinc-air (Zn∥O₂), and Ni—Zn (Zn∥NiOOH) are being commercialized as rechargeable batteries. Each of these uses an alkaline electrolyte, most commonly based on a high concentration of NaOH or KOH. Rechargeability of these cells is limited due to tendency of zinc to form dendrites in an alkaline electrolyte during recharge of the cell (Zn plating). These dendrites may grow from the negative electrode to the positive electrode and may result in the cell experiencing an internal short circuit.

The development of aqueous battery systems using mild (pH ˜4 to ˜6) aqueous electrolytes has progressed rapidly in recent years, including monovalent Li⁺, Na⁺ and K⁺ and divalent Mg2⁺ along with the aqueous rechargeable zinc battery (hereinafter, zinc-ion battery). The merits of the zinc-ion battery have substantially raised their application potential in large-scale energy storage systems. However, most of the research and development is focused on electrode materials discovery at the lab scale while the electrode and cell engineering aspects are often overlooked.

A zinc-ion battery is provided with: a positive electrode in which a positive electrode composite layer including a positive electrode active material is disposed on one or both sides a positive electrode current collector; a negative electrode in which a negative electrode composite layer including a zinc material such as a zinc foil or zinc powder is disposed on one or both sides of a negative electrode current collector; and a separator wetted by an aqueous electrolyte solution including water and an electrolyte salt such as a zinc salt.

Because the capacity (amount of charge) and energy of the zinc-ion battery are dictated by the amount of zinc that can be stored in the positive electrode, it is desirable to increase both the specific capacity (expressed in mAh·g⁻¹) and the areal loading (expressed in mg·cm⁻²) of the positive electrode active material. Increasing the loading from lab-scale battery research (1-5 mg·cm⁻²) to commercial production (20-50 mg·cm⁻²) presents numerous challenges.

It has been determined that the current collector at the positive electrode may become anodized and corroded under high voltages due to the action of an electrolyte such as a zinc salt contained in the aqueous solution. Upon such anodization and corrosion, the cycle characteristics and battery capacity are deteriorated. Aluminium (Al) is the most preferred positive electrode current collector in lithium-ion batteries due to its ability to form a passive film, making the nonaqueous electrolyte∥Al interface stable even at potentials >4 V vs. Li/Li⁺. In aqueous electrolytes, however, no such passive film is formed, and aluminum is severely corroded at potentials >1V vs Zn/Zn²⁺. A preferred current collector material for traditional alkaline zinc batteries is nickel (or nickel-coated steel), as nickel may exhibit excellent stability in alkaline (pH >10) electrolytes. However, when analyzing the capacity deterioration factors of zinc cells using mild (pH ˜4 to ˜6) aqueous electrolytes, corrosion of the nickel current collector due to local changes in pH at the positive electrode∥electrolyte interface was the main factor.

Attempts to solve the foregoing problem have included switching to materials with higher corrosion resistance in a mild (pH ˜4 to ˜6) aqueous electrolyte such as stainless steel (300 series) or carbon (such as carbon paper or graphite foil). However, in such a development orientation, positive electrode adhesion and/or mechanical strength have been reduced. Due to high surface smoothness, mechanical strength, ductility, and malleability of stainless steel, adhesive strength between the active composite layer and the current collector foil is reduced during rolling, calendering, cutting and other processing steps involved in the fabrication of a battery. Meanwhile, carbon-based current collectors lack the mechanical strength required for large-scale manufacturing (such as roll-to-roll coating, slitting, punching, etc.). Tearing of the current collector during cell assembly or cycling may lead to the immediate and permanent failure of the battery. Furthermore, carbon materials cannot be welded, which may pose additional technical challenges.

Accordingly, it is desired to provide a positive electrode for use in a zinc-ion battery that overcomes at least some of the shortcomings of existing commercially available current collectors and binders designed for other types of batteries.

### SUMMARY

A rechargeable battery is provided. The rechargeable battery includes a zinc metal negative electrode, an electrolyte having a pH between 3.5 and 6.5, and a positive electrode. The positive electrode includes a current collector and a primer coating layer applied to the current collector to form a primer-coated current collector for protecting the current collector from the electrolyte. The primer coating layer includes a binder and a conductive filler.

A rechargeable battery is provided. The rechargeable battery includes a zinc metal negative electrode, an electrolyte having a pH between 3.5 and 6.5, and a positive electrode. The positive electrode includes a current collector and a positive electrode composite layer. The positive electrode composite layer includes a hydrophilic binder, a conductive additive, and a material that undergoes reversible faradaic reactions with zinc ions.

A positive electrode for use in a rechargeable battery including the positive electrode, a zinc metal negative electrode, and an electrolyte having a pH between 3.5 and 6.5 is provided. The positive electrode includes a current collector and a primer coating layer applied to the current collector to form a primer-coated current collector for protecting the current collector from the electrolyte. The primer coating layer includes a binder and a conductive filler.

A positive electrode for use in a rechargeable battery including the positive electrode, a zinc metal negative electrode, and an electrolyte having a pH between 3.5 and 6.5 is provided. The positive electrode includes a current collector and a positive electrode composite layer. The positive electrode composite layer includes a hydrophilic binder, a conductive additive, and a material that undergoes reversible faradaic reactions with zinc ions.

The negative and positive electrodes may be separated from each other by a porous separator.

The negative electrode may be a zinc alloy.

The current collector may include one or more corrosion-resistant alloys.

The primer coating layer may be 1 to 10% as thick as the positive electrode composite layer.

The primer coating layer may further include a solvent, the solvent may be organic or water, and, if the solvent is water, the binder of the primer coating layer may be cross-linked or cured.

The binder of the primer coating layer may be 10 to 80 wt % with respect to a total weight of the primer coating layer.

The conductive filler of the primer coating layer may include carbon materials as a particulate filler or a fibrous filler.

A volume resistivity of the primer coating layer may be 0.001 to 1 Ω·cm.

The binder of the primer coating layer may be hydrophobic.

The binder of the primer coating layer may be hydrophilic.

The positive electrode may include any one or more of a manganese-based oxide, a vanadium-based material, a Prussian blue analogue, a Chevrel phase, a polyanionic compound, a metal disulfide, and an organic compound.

The positive electrode may include any one or more of nickel, stainless steel, and titanium.

The current collector may include any one or more of a smooth foil, a rough electrodeposited foil, a wire, a sheet, a plate, a foam, a sponge, and a mesh.

The current collector may include a smooth foil, and the smooth foil current collector may be pre-treated to increase surface area by way of any one or more of chemical etching and electrolytic etching.

The primer coating layer may coat a side of the current collector that is oriented facing the positive electrode composite layer.

The primer coating layer may coat all sides of the current collector.

The primer coating layer may provide a network of porous structures to increase available surface area of the current collector, the primer coating layer may have a thickness of about 1 μm to 20 μm, and the primer coating layer may be a film-type layer having a uniform thickness.

The primer coating layer may provide a network of porous structures to increase available surface area of the current collector, the primer coating layer may have a thickness of about 1 μm to 20 μm, and the primer coating layer may be a cluster-type layer having a non-uniform thickness.

The primer coating may have an average surface roughness of about 0.3 μm to 5 μm.

A surface of the primer-coated current collector exposed to the electrolyte may be substantially hydrophobic or super-hydrophobic.

A surface of the primer-coated current collector exposed to the electrolyte may be hydrophilic.

The conductive filler of the primer coating layer may include a conductive carbon filler, and the conductive carbon filler may include any one or more of a particulate carbon filler and a fibrous carbon filler.

The particulate carbon filler may include any one or more of ketjen black, acetylene black, nanoporous carbon, natural graphite, artificial graphite, furnace black, and channel black, the average primary particle diameter of the particulate carbon filler may be 0.010 to 1 μm, the particulate carbon filler may be at least 20 wt % of the carbon filler, and a weight ratio of the conductive filler to the binder may be between 10% and 90%.

The fibrous carbon filler may include any one or more of carbon fibers, carbon nanotubes, and carbon nanofibers, the diameter of the fibrous carbon may be 0.1 to 15 μm, a ratio of average fiber length/average fiber diameter may be between 10 and 500, and a weight ratio of the conductive filler to the binder may be between 10% and 90%.

The binder of the primer coating layer may include any one or more of polyimide copolymers, acrylate copolymers, ethyl cellulose, polyvinylidene fluoride (PVdF), tetrafluoroethylene (TFE), polyethylene (PE), polypropylene (PP), ethylene-propylene-diene terpolymer (EPDM), sulfonated EPDM, alkyl vinyl ether, and fluororubbers, and the binder of the primer coating layer may be soluble in an organic solvent.

The hydrophilic binder may be any one of a polyvinyl butyral, a polyvinyl formal, a polyvinyl acetate, a perfluorosulfonic acid (PFSA)-based polymer, a branched polyethylenimine, and a poly(4-vinylbenzoic acid).

The hydrophilic binder may be formed by any one of chemical cross-linking of a polyvinyl alcohol (PVAOH) with boric acid, imidization of a polyamic acid to form a polyimide (PI), cross-linking of an alginate with Ca²⁺ or Zn²⁺, crosslinking of a polyacrylic acid (PAA) with a PVAOH, and curing of an alkoxysilyl group-containing resin.

The positive electrode composite layer may further include a conductive additive.

The conductive additive may be a carbon conductive additive.

The carbon conductive additive may include any one or more of a particulate additive or fibrous additives.

The ratio of particulate carbon to total carbon conductive additive weight may be between 70% and 99% and carbon additive content may be between 5 and 15 wt % of the positive electrode composite layer.

The positive electrode composite layer may further include a plasticizer.

The plasticizer may be based on oxalic acid, malonic acid, glutaric acid, succinic acid, adipic acid, pimelic acid, azelaic acid, sebacic acid, terephthalic acid, phthalic acid, isophthalic acid, or cyclohexane dicarboxylic acid.

The positive electrode composite layer may further include a gelling agent for improving interfacing with the electrolyte and preventing dehydration of the positive electrode throughout a cycle-life of the rechargeable battery.

The gelling agent may include any one or more of a polyacrylic acid, a grafted starch material, a salt of a polyacrylic acid, a microcrystalline cellulose, a nanocrystalline cellulose, a carboxymethylcellulose, a salt of a carboxymethylcellulose, a gelatin, a carrageenan, a chitosan, a polyethylene oxide, a glyceryl monostearate, a polyvinyl pyrrolidone, a polyvinyl alcohol, and a clay material.

The positive electrode composite layer may include between 0.1 wt % and 2 wt % of the gelling agent.

The primer-coated current collector may be prepared in advance, stored, and used on demand for the preparation of the positive electrode.

A continuous fabrication process may be used to produce the positive electrode and the primer-coated current collector may be prepared in line with the positive electrode.

A method for manufacturing a primer coated current collector for use in a positive electrode in an aqueous zinc rechargeable battery is provided. The method includes adding a carbon conductive filler to a polymeric binder to form a primer mixture and applying the primer mixture to the current collector to form the primer-coated current collector.

The method may further include applying a pre-treatment to increase surface area of a current collector.

The method may further include applying a post-treatment to the current collector to yield the primer-coater current collector.

Adding the carbon conductive filler to the polymeric binder to form the primer mixture may include any one or more of mechanical agitation, grinding, ultrasonication, and ball milling in the presence of a solvent.

The solvent may include any one or more of acetone, N-methyl-2-pyrrolidone (NMP), methanol, dimethyl formamide (DMF) isopropanol, and water, and mixtures or solutions thereof.

The primer mixture may be applied by any one or more of tape casting, slot die coating, reverse roll coating, and spray-painting.

The primer mixture may be applied as any one or more of a slurry, paste, and ink in a volatile solvent to the surface of the current collector.

The primer mixture may be applied as a dry powder mixture for spraying.

The method may further include any one or more of curing, drying, and insolubilization treatment of the primer mixture to yield a dry primer-coated current collector.

The post-treatment may include any one or more of sintering, pressing, curing, and calendaring.

A method of manufacturing a positive electrode for use in an aqueous rechargeable zinc battery operating in an electrolyte having a pH between 3.5 and 6.5 is provided. The method includes adding a carbon conductive additive, an electrode active material, and a gelling agent to a hydrophilic polymeric binder to form an electrode composite mixture and applying the electrode composite mixture to a primer-coated current collector. The primer may protect the current collector from the electrolyte.

The method may further include drying the electrode composite mixture to yield the aqueous rechargeable zinc battery.

The carbon conductive additive, the electrode active material, and the gelling agent may be added to the hydrophilic polymeric binder in the presence of a solvent.

The solvent may include any one or more of acetone, N-methyl-2-pyrrolidone (NMP), methanol, dimethyl formamide (DMF) isopropanol, benzyl alcohol, diacetone alcohol, dioxane, acetophenone, and mixtures or solutions thereof.

The positive electrode composite layer may be applied to the current collector by any one or more of tape casting, slot die coating, reverse roll coating, and spray-painting.

The primer mixture may be applied as one of a slurry, paste, and ink in a volatile solvent to the surface of a surface of the current collector.

The primer mixture may be applied as a dry powder mixture for spraying.

The positive electrode composite layer may undergo any one or more of curing, drying, and insolubilization treatments to yield a dry positive electrode.

The positive electrode may undergo any one or more of sintering, pressing, curing and calendaring to effect binding of the positive electrode composite layer to the primer-coated current collector.

A rechargeable battery is provided. The rechargeable battery includes a zinc metal negative electrode, an electrolyte having a pH between 3.5 and 6.5, and a positive electrode. The positive electrode includes a current collector and a primer coating layer applied to the current collector to form a primer-coated current collector for protecting the current collector from the electrolyte. The primer coating layer includes a binder and a conductive filler. The positive electrode further includes a positive electrode composite layer applied to the primer coating layer. The positive electrode composite layer includes a hydrophilic binder, a conductive additive, and a material that undergoes reversible faradaic reactions with zinc ions.

The electrolyte may have a pH between 4 and 6.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a schematic diagram of a side view of a positive electrode including a primer coating layer, in accordance with an embodiment;

FIG. 2A is schematic diagram of a side view of the positive electrode of FIG. 1 being wetted by an electrolyte;

FIG. 2B is a schematic diagram of a side view of the positive electrode having no primer coating layer being wetted by an electrolyte;

FIG. 3 is a graph depicting anodic stability of various stainless-steel current collectors versus Zn in a mild aqueous electrolyte;

FIG. 4 is a flow chart of a method of fabricating a primer-coated current collector to use as a positive electrode in a zinc-ion battery, in accordance with an embodiment;

FIG. 5A is an image illustrating the wetting of a positive electrode comprising an electrode composite layer using a hydrophilic binder, according to an embodiment;

FIG. 5B is an image illustrating the wetting of a positive electrode comprising an electrode composite layer using a hydrophobic binder;

FIG. 5C is an image illustrating the wetting of a positive electrode comprising a primer-coated current collector comprising stainless steel;

FIG. 6 is a graph depicting the capacity over cycle number for aqueous rechargeable zinc batteries including either a positive electrode comprising an electrode composite layer using a hydrophilic binder or an electrode composite layer using a hydrophobic binder;

FIG. 7 is a graph depicting the capacity over cycle number for aqueous rechargeable zinc batteries including either a positive electrode comprising an electrolyte gelling agent or a positive electrode without any electrolyte gelling agent;

FIG. 8 is a flow chart of a method of fabricating a positive electrode including an electrode composite layer having a hydrophilic binder, in accordance with an embodiment;

FIG. 9 is a graph depicting first and second cycles of aqueous rechargeable batteries using a positive electrode including a primer coating in between a current collector and an electrode composite layer, according to an embodiment of the present disclosure, and aqueous rechargeable batteries using a positive electrode having an electrode composite layer and no primer coating, in accordance with another embodiment;

FIG. 10 is a graph depicting anodic stability of uncoated stainless steel and primer-coated stainless steel using linear sweep voltammetry at a scan rate of 0.1 mV/s in 1 M ZnSO₄+0.2 M MnSO₄;

FIG. 11A is a graph depicting the voltage profiles for the first cycle of cells using zinc negative electrodes and a PVF-based positive electrode coating on a bare stainless steel current collector and primer-coated stainless steel current collector;

FIG. 11B is a graph depicting capacity retention of the cells of FIG. 11A;

FIG. 12 is a graph depicting chronopotentiometry of a primer coated stainless steel current collector at 0.2 mA/cm² in 1 M ZnSO₄ and 1 M ZnSO₄+0.2 M MnSO₄ electrolytes;

FIG. 13A is an optical image of pristine stainless steel;

FIG. 13B is an optical image of stainless steel after plating MnO₂ at 1.8 V;

FIG. 13C is a SEM image of pristine stainless steel; and

FIG. 13D is a SEM image of stainless steel after plating MnO₂ at 1.8 V.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

As used herein, the term “about” or the approximate symbol “˜”, when used in reference to a pH value, means the pH value given +/−0.5, unless otherwise stated. When the term “about” or the approximate symbol “˜” is used in reference to a pH range, it is understood that the forgoing definition of “about” is to be applied to both the lower limit and upper limit of the range.

As used herein, the term “about”, when used in reference to a molar concentration (“molar”) value, means the molar value +/−0.1 molar, unless otherwise stated. When the term “about” is used in reference to a molar range, it is understood that the forgoing definition of “about” is to be applied to both the lower limit and upper limit of the range.

As used herein, the term “between”, when used in reference to a range of values such as a molar range or a pH range, means the range inclusive of the lower limit value and upper limit value, unless otherwise stated. For example, a pH range of “between 4 and 6” is taken to include pH values of 4.0 and 6.0.

The present disclosure relates generally to improving the performance of primary and secondary electrochemical cells that use zinc metal as the negative electrode and a mild (pH ˜4 to ˜6) aqueous solution or gel as the electrolyte.

The present disclosure relates more particularly to improving the performance of the positive electrode in zinc-ion batteries, by way of positive electrode compositions and architectures.

In an embodiment, there is provided a rechargeable battery including a zinc metal negative electrode, an electrolyte having a pH between 3.5 and 6.5, and a positive electrode including a current collector and a primer coating layer applied to the current collector for protecting the current collector from the electrolyte, the primer coating including a binder and a conductive filler.

The electrolyte may have a pH between 4 and 6.

In some embodiments, the primer coating may preferably be a hydrophobic primer coating. In other embodiments, the primer coating may be a hydrophilic primer coating.

In an embodiment, there is provided a rechargeable battery including a zinc metal negative electrode, an electrolyte having a pH between 3.5 and 6.5, and a positive electrode including a current collector and an electrode composite layer, the electrode composite layer including a hydrophilic binder, a conductive additive, and a material that undergoes reversible faradaic reactions with zinc ions.

The electrolyte may have a pH between 4 and 6.

In an embodiment, the primer coating includes carbon, a binder, and a solvent. The solvent may be an organic solvent or water. If the solvent is water, a soluble binder may be crosslinked to render the binder insoluble in a water-based electrolyte. The crosslinking may be performed, for example, using a curing step.

In an embodiment, an active coating includes an active material, carbon, a binder, a solvent, and one or more other additives. The solvent may be an organic solvent or water. If the solvent is water, a soluble binder may be crosslinked to render the binder insoluble in a water-based electrolyte. The crosslinking may be performed, for example, using a curing step.

In an embodiment, the positive electrode 1 may not include the primer coating layer 20.

In an embodiment, there is provided a rechargeable battery including a zinc metal negative electrode, an electrolyte having a pH between 3.5 and 6.5, and a positive electrode including a current collector, a primer coating layer applied to the current collector for protecting the current collector from the electrolyte, the primer coating including a binder and a conductive filler, and an electrode composite layer, the electrode composite layer including a hydrophilic binder, a conductive additive, and a material that undergoes reversible faradaic reactions with zinc ions.

The electrolyte may have a pH between 4 and 6.

In an embodiment, the binder of the primer coating 20 may be hydrophilic.

In an embodiment, the binder of the primer coating 20 may be hydrophobic.

Further, as the positive electrode active material, any material capable of reversibly storing zinc ions from a mild (pH ˜4 to ˜6) aqueous electrolyte via any one or more of surface adsorption/desorption, pseudocapacitive reactions, intercalation/deintercalation, and conversion reactions may be used. Example materials include manganese-based oxides (e.g. MnO₂ polymorphs), vanadium-based materials (e.g. V₂O₅ and derivatives), Prussian blue analogues (e.g. Zn₃[Fe(CN)₆]₂), Chevrel phases (e.g. ZnMo₆S₈), polyanionic compounds (e.g. Na₃V₂(PO₄)₂F₃), metal disulfides (e.g. VS₂) and organic compounds (e.g. calix [4]quinone). The present disclosure may be applied to any of the above listed materials, to any suitable material yet to discovered, or to any combinations thereof.

The present disclosure addresses the identified shortcomings in the art, and provides a positive electrode for an aqueous rechargeable battery including a primer coating layer including a binder and a conductive material and applied on a current collector, to prevent or suppress adverse reactions between the current collector and an electrode composite layer including a hydrophilic binder and an electrode active material and applied on the primer coating layer, where the hydrophilic binder is substantially insoluble in water and mild (pH ˜4 to ˜6) aqueous electrolyte.

As a result of a variety of extensive and intensive studies and experiments to solve the foregoing problems, such as those related to corrosion and adhesion, the present disclosure provides the use of metal coated with a primer layer, the primer layer including a conductive material and a polymer material, as a positive electrode current collector for a zinc-ion battery. The primer-coated current collector of the present disclosure solves various problems encountered with corrosion and adhesion in conventional smooth metal current collectors.

Any suitable metal may be used without particular limitation as the metallic base so long as the metal is stable within the operating voltage window of the zinc-ion battery and supplies and transmits electrons. Examples of suitable metals include nickel, stainless steel, and titanium, preferably stainless steel.

The metallic current collector may be a smooth foil, a rough electrodeposited foil, a wire, a sheet, a plate, a foam, a sponge, or a mesh.

If the metallic current collector is a smooth foil, the metallic current collector may be pre-treated to increase its surface area. The pre-treatment may be performed using chemical and/or electrolytic etching. Any reagents and methods known in the art may be employed. For example, chemical etchants such as Adlers, Carpenter, Kalling' No.2 or Marble's reagent may be applied to stainless steel by way of immersing, dipping, swabbing or spraying. In another example, electrolytic etching may be conducted in an oxalic acid bath but is not limited thereto.

The present disclosure may provide improvement to the adhesion of a positive electrode composite layer to a metallic current collector for an aqueous rechargeable zinc battery.

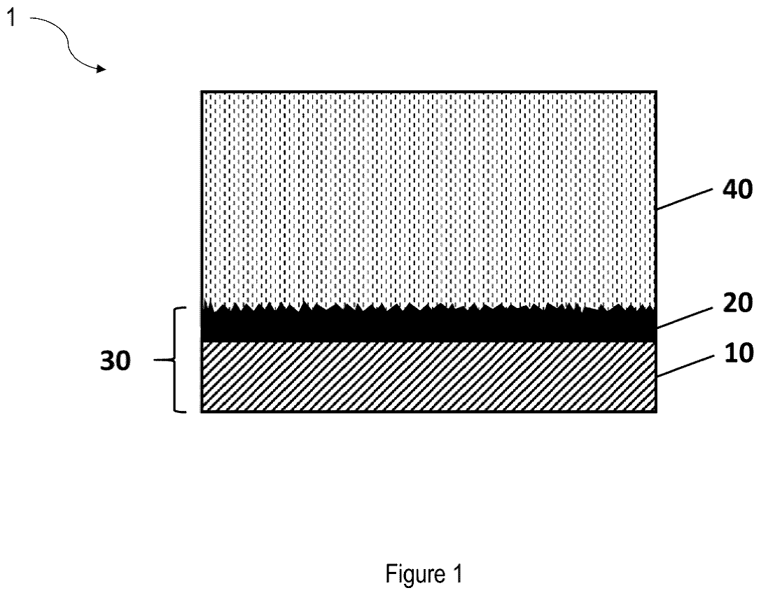

Referring now to FIG. 1, shown therein is an architecture of a positive electrode 1, according to an embodiment. The positive electrode 1 may be used as the positive electrode in a zinc-ion cell or aqueous rechargeable cell.

The positive electrode 1 includes a primer-coated current collector 30 and an electrode composite layer 40. The primer-coated current collector 30 includes a primer coating layer 20 (also referred to as primer coating 20, primer layer 20, or primer 20) applied to the current collector 10. The primer coating layer 20 may prevent corrosion and/or passivation. In this case, corrosion is oxidation or dissolution of the underlying current collector metal during charge of the zinc-ion battery (e.g Ni→Ni²⁺+2e⁻). Passivation is a significant increase in resistance of the current collector surface as the result of the formation of an insulating metal oxide (e.g. Mn²⁺+2H₂O→MnO₂+4H⁺+2e⁻). The primer coating layer 20 is positioned between the current collector 10 and the electrode composite layer 40.

The primer coating layer may include a binder and a conductive material. The primer coating layer, when applied on a current collector, may be used to prevent or suppress adverse reactions between the current collector and electrolyte.

The primer coating layer 20 may improve adhesion between the current collector 10 and the electrode composite layer 40. The electrode composite layer 40 may achieve a combination of cohesive and adhesive strength and appropriate electrolyte transport.

The primer coating 20 may be applied on one or both sides or surfaces of the current collector 10, preferably on both surfaces thereof. Preferably, both sides of the current collector 10 are coated with the primer coating 20, as both sides of the current collector 10 may make contact with the electrode composite layer 40.

The primer coating 20 provides a network of porous structures to effectively increase available surface area of the current collector 10. Advantageously, the increased available surface area of the current collector 10 provided by the primer coating 20 may provide a greater surface area to which the electrode composite layer 40 can adhere than would otherwise be available without the primer coating 20 (e.g. using just current collector 10).

In an embodiment, the primer coating layer 20 may include a conductive material (filler) and a polymer (binder) (not shown).

In an aspect, the electrode composite layer 40 may be an electrode composite slurry.

In an embodiment, the primer coating layer 20 may coat a side of the current collector 10 that is oriented facing the electrode composite layer 40.

In an embodiment, the primer coating layer 20 may substantially coat substantially all sides of the current collector 10.

In an aspect, the primer coating layer 20 may be 1 to 10% as thick as the electrode composite layer 40.

Preferably, the primer coating 20 may have a thickness of about 100 nm to 50 μm. More preferably, the primer coating 20 may have a thickness of about 1 μm to 20 μm.

The primer coating 20 may be a film-type layer having a uniform thickness.

The primer coating 20 may be a cluster-type layer having a non-uniform thickness. The cluster-type primer coating 20 may advantageously have a high surface area compared to a film-type layer, thereby providing greater adhesive strength than the film-type primer coating 20 when the cathode active material is attached thereto.

Advantageously, the primer-coated current collector 30 may provide improved corrosion resistance compared to an implementation using the current collector 10 without the primer layer 20.

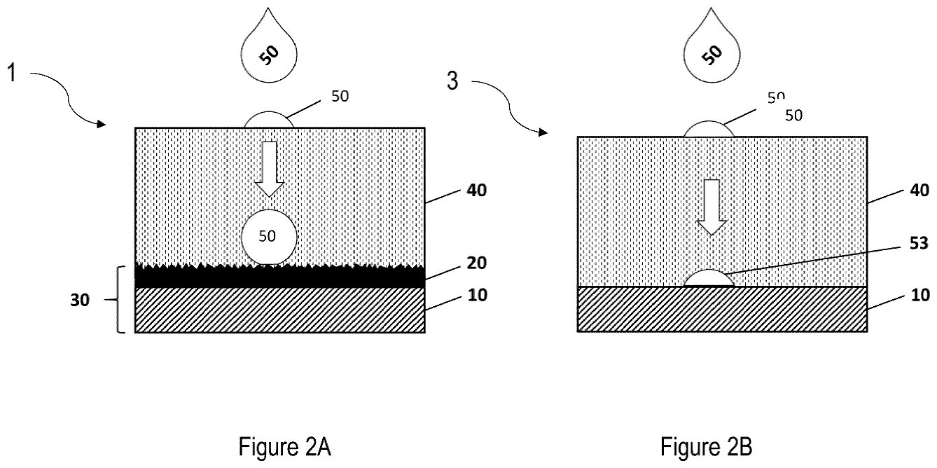

Corrosion resistance may be realized by rendering a surface of the primer-coated current collector 30 that exposed to an electrolyte (not shown) substantially hydrophobic, that is with a water contact-angle >90°. Preferably, the surface of the primer-coated current collector 30 exposed to the electrolyte is rendered super-hydrophobic, that is with a water contact-angle >150°. The hydrophobicity and super-hydrophobicity are shown in FIGS. 2A and 2B.

In an embodiment, the positive electrode 1 may include the current collector 10 and the primer coating layer 20 applied to the current collector 10 for protecting the current collector 10 from the electrolyte 50. The primer coating layer 20 may include a binder and a conductive filler. In an embodiment, the positive electrode 1 may not include the electrode composite layer 40.

In an embodiment, the positive electrode 1 may include the current collector 10 and the electrode composite layer 40. The electrode composite layer 40 may include a hydrophilic binder, a conductive additive, and a material that undergoes reversible faradaic reactions with zinc ions.

FIG. 1 is a schematic of the positive electrode 1 including a primer layer 20.

Referring now to FIGS. 2A and 2B, shown therein are schematic representations of wetting of the positive electrode 1 of FIG. 1 (including the primer-coated current collector 30 including a hydrophobic primer 20) with an electrolyte 50 (FIG. 2A) and wetting of a positive electrode 3 having no primer coating layer with the electrolyte 50 (FIG. 2B).

As can be seen in FIG. 2A, the primer coating layer 20 prevents exposure of the current collector 10 to the electrolyte 50.

In contrast, as can be seen in FIG. 2B, the positive electrode 3 does not includes a primer coating layer 20 (and thus no primer-coated current collector 30) and the current collector 10 is exposed to the electrolyte 50.

In FIG. 2A, a drop of mild (pH ˜4 to ˜6) aqueous electrolyte 50 penetrates a hydrophilic surface of the electrode composite layer 40 The electrolyte drop 50 penetrates and wets the porosity of the composite layer 40.

The droplet of electrolyte 50 reaches a hydrophobic interface adjacent to where the electrode composite layer 40 meets the primer coated current collector 30.

In FIG. 2A, the hydrophobic character of the primer coating 20 drastically prevents exposure of the current collector 10 to the aqueous electrolyte 50.

In FIG. 2B, a drop 50 similarly penetrates the hydrophilic surface of the electrode composite layer 40. In the absence of the primer coating layer 20, there is no hydrophobic interface, and so the current collector 10 is exposed to the aqueous electrolyte 50. Accordingly, the bare current collector 10 exhibits a typically hydrophilic character. Hereinafter hydrophilicity is defined by a water contact-angle <90°.

The present disclosure may provide a primer-coated current collector 30 that maintains electronic conductivity through a primer 20 having high conductivity and/or low resistivity, so as not to impede charge transfer between the electrode composite layer and the current collector 30. A suitable volume resistivity of the primer coating layer 20 is 0.001 to 50 Ω·cm, and preferably 0.001 to 1 Ω·cm.

Generally, to achieve a combination of adhesive strength, corrosion resistance, and electronic conductivity, the primer coating layer 20 may include a binder and a conductive carbon filler. The binder may be a polymer.

Examples of suitable binders include polyimide copolymers, acrylate copolymers such as poly(methyl methacrylate) (PMMA), ethyl cellulose, polyvinylidene fluoride (PVdF), tetrafluoroethylene (TFE), polyethylene (PE), polypropylene (PP), ethylene-propylene-diene terpolymer (EPDM), sulfonated EPDM, alkyl vinyl ether and the like, or fluororubbers, but are not limited thereto.

In some embodiments, the binder is soluble in an organic solvent (e.g., acetone). By soluble it is meant that the solubility of the binder in an organic solvent is greater than the solubility of polytetrafluoroethylene in the organic solvent.

The conductive carbon fillers may be particulate fillers, fibrous fillers, or combinations thereof.

Examples of particulate carbon filler that may be used in the primer coating layer 20 include ketjen black, acetylene black, nanoporous carbon, graphite (natural graphite, artificial graphite), furnace black, channel black, etc.

The average primary particle diameter of the particulate carbon filler is preferably 0.002 to 20 μm, and more preferably 0.010 to 1 μm.

Examples of the fibrous carbon filler that may be used in the primer coating layer 20 include carbon fibers, carbon nanotubes, and carbon nanofibers.

The diameter of the fibrous carbon is preferably 20 μm or less, and more preferably 0.1 to 15 μm.

Further, the ratio of average fiber length/average fiber diameter is preferably 5 or more, and more preferably 10 or more. Moreover, it is preferable that the ratio of average fiber length/average fiber diameter is 1000 or less, and more preferably 500 or less.

The particulate carbon filler and the fibrous carbon filler may be used in combination. As the mixing ratio of the particulate carbon filler/fibrous carbon filler, the particulate carbon filler is preferably 10% by mass or more, more preferably 20% by mass or more.

The primer coating 20 may function to suppress anodic corrosion and increase adhesive strength of the active material of the positive electrode 1 to the metallic current collector 10.

Preferably, the weight ratio of the conductive filler to the binder in the primer coating layer 20 may be in the range of 10% to 90%. It is recognized that when the content of the conductive material filler in the primer coating layer 20 is too low, internal resistance increases, which may negatively impact battery performance. It is further recognized that when the content of the polymer material of the binder in the primer coating layer 20 is too low, adhesive strength may be negatively impacted (e.g. to where desired adhesive strength cannot be achieved). Thus, the weight ratio of the conductive filler to the binder in the primer coating layer 20 may be selected within the range described above (10% conductive filler to 90% binder), and may more preferably be selected to be in the range of 20% to 80% weight ratio of conductive filler to binder. Furthermore, the mixing ratio may be appropriately selected in consideration of the conductivity and density of each carbon filler, the elasticity and flexibility of the generated primer coating layer 20, and the like.

The primer coating 20 may include an adhesion promoter for increasing adhesion of the primer coating 20 to the current collector 10 and/or to the electrode composite layer 40.

The adhesion promoter may be any of a maleic anhydride grafted PVDF, a silane-based adhesion promoter, an epoxy-based chemical, an EVOH, acrylate polymer, an acrylate copolymer, an acetal copolymer, a thermoplastic with high polarity, or a combination thereof.

The adhesion promoter may be a plasticizer based on any one or more of oxalic acid, benzoic acid, malonic acid, glutaric acid, succinic acid, adipic acid, pimelic acid, azelaic acid, sebacic acid, terephthalic acid, phthalic acid, isophthalic acid, and cyclohexane dicarboxylic acid.

FIG. 2A is a schematic of the positive electrode 1 including the primer 20 wetted by the electrolyte 50.

FIG. 2B is a schematic of a positive electrode 3 without the primer 20 wetted by the electrolyte 50.

Many different hydrophobic compositions for the primer coating 20 were examined and some representative examples are listed in Table 1 below, summarizing the resistivity and hydrophobicity of each.

TABLE 1
Resistivity and Hydrophobicity of Primer Coating Materials

| | Volume | |
|---|---|---|
| | resistivity | Water contact- |
| Composition | (Ω · cm) | angle (°) |
| Comparative Example 1. No primer | 1.0 · 10⁻⁴ | 82 |
| Example 1. PVDF | 4.0 · 10⁻⁴ | 136 |
| Example 2. Lumiflon | 1.2 · 10⁻² | 160 |
| Example 3. Bonderite-Lumiflon | 7.4 · 10⁻³ | 123 |
| Example 4. Bonderite | 3.6 · 10⁻⁴ | 75 |
| Example 5. PAA/CMC crosslinked | | 14 |
| binders | | |

From Table 1, it may be observed that the best apparent results in terms of conductivity (i.e., low resistivity) were obtained for the primer-coated current collector 30 of Example 1 and Example 4 (<0.001 Ω·cm). It is, however, apparent that the primer-coated current collector 30 of Example 4 is hydrophilic (contact-angle <90°), while the primer-coated current collectors 30 of Example 1 and Example 2 are hydrophobic (contact-angle >90°) and superhydrophobic (contact-angle >150°), respectively. Among the given examples, the candidate most apparently combining low resistivity and high hydrophobicity seems to be Example 1, where the primer coating 20 comprises a commercial PVDF-HFP (KynarFlex 8200) binder. Example 3, where a commercial FEVE dispersion (Lumiflon) is combined with a Bonderite EB-12 carbon adhesive, may also provide a satisfactory compromise between the superhydrophobicity of the Lumiflon and the excellent conductivity of the Bonderite.

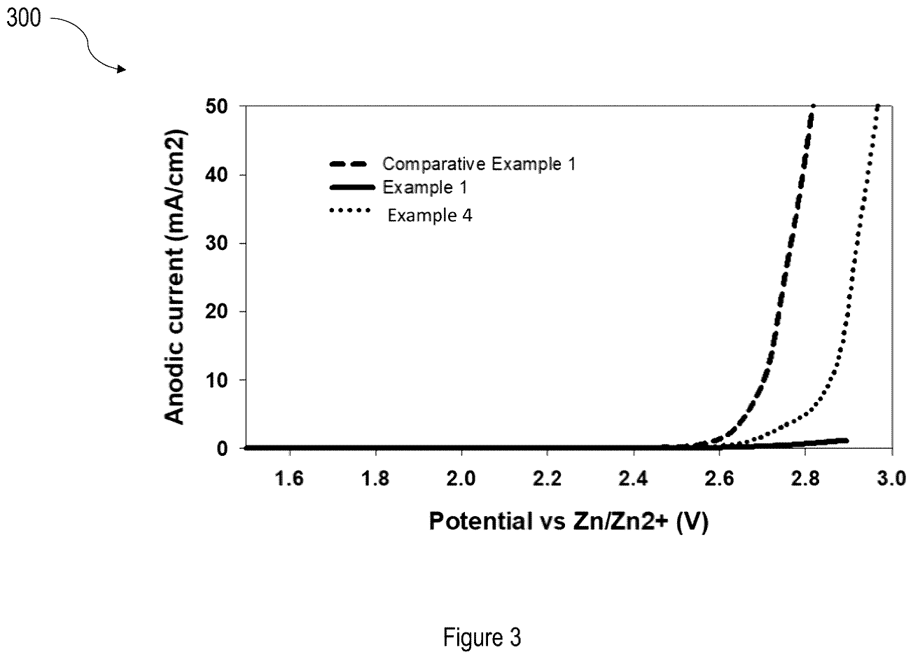

Referring now to FIG. 3, shown therein is a graph 300 comparing anodic stability (i.e., corrosion resistance) of a primer-coated current collector 30 of Example 1 and of Example 4 compared to a bare metallic current collector 10 of Comparative Example 1, to assess corrosion resistance of different compositions of the primer coatings 20. Anodic stability of carbon is generally superior to that of other metals (such as stainless steel or nickel), and there may accordingly be benefits to the use of a carbon-based primer coating layer 20.

The experimental data show that, while the hydrophilic primer coating 20 of Example 4 may offset the oxygen evolution reaction by +0.2 V as compared to the bare stainless steel foil of Compare Example 1, the hydrophobic primer coating 20 of Example 1 effectively suppresses any oxygen evolution up to 3.0 V vs Zn/Zn²⁺. By preventing exposure of the metallic current collector 10 to the electrolyte 50, reactivity is thereby suppressed. Such combination of high electronic conductivity and hydrophobicity may be desirable for the primer-coated current collector 30 in use.

FIG. 3 shows anodic stability of primer layers 20.

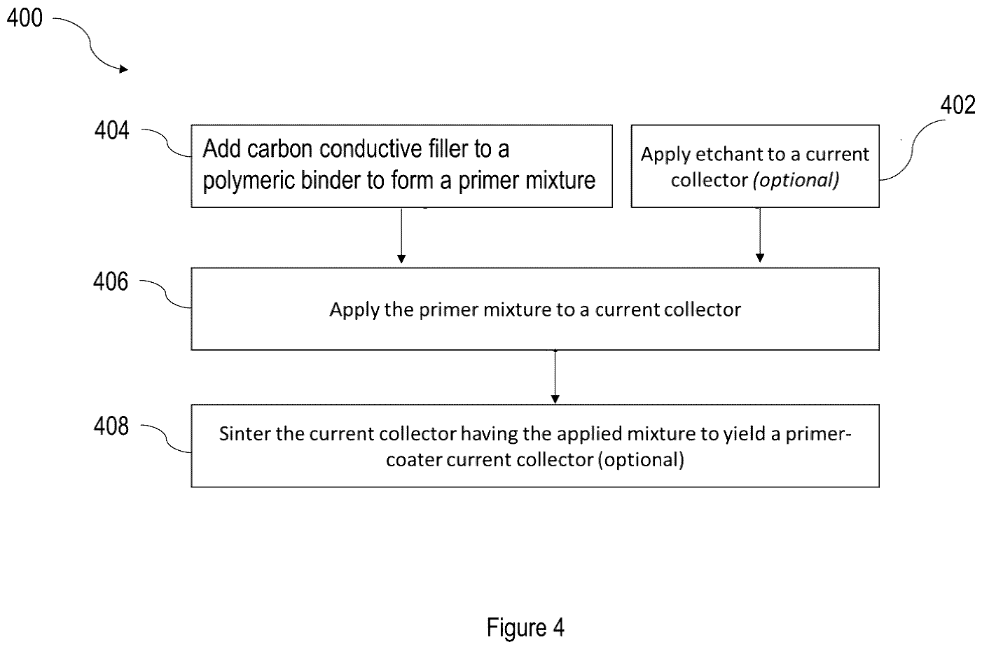

Referring now to FIG. 4, shown therein is a flow chart of a method 400 of preparing a primer-coated current collector, such as the primer-coated current collector 30 of FIG. 1, according to an embodiment.

Optionally, at 402, the method 400 may include a pre-treatment to increase surface area of the metallic current collector 30.

At 404, a carbon conductive filler is added to a polymeric binder to form a primer mixture.

At 406, the primer mixture is applied to the current collector 10.

Optionally, at 408, the current collector 10 to which the primer mixture was applied is sintered to yield the primer-coated current collector 30.

Each of 402, 404, 406, and 408 is discussed in further detail hereinbelow.

FIG. 4 shows a flow chart for primer layer 20 preparation.

The components of the primer coating 20 may be mixed at 404 using any suitable method. The mixing method may be selected so as to obtain a desired dissolution, dispersion, or suspension of the solid components in a carrier solvent(s). The mixing method may be selected so as to obtain a dry mixture of the solid components. The method of mixing may include, but is not limited to, one or more of mechanical agitation, grinding, ultrasonication, and ball milling.

The solvent may be acetone, N-methyl-2-pyrrolidone (NMP), methanol, dimethyl formamide (DMF) isopropanol, water, mixtures or solutions thereof, or any solvent that will serve to thoroughly mix the binder with the carbon conductive filler for application to the current collector 10. Typically, the solvent is one that will dissolve the binder. The solvent may be selected based on the specific carbon filler used, the specific binder material selected, availability of materials, or preferences of the user.

The primer coating mixture 20 may be applied by, for example, tape casting, slot die coating, reverse roll coating, or spray-painting. The primer coating mixture 20 may be delivered as a slurry, a paste, or an ink, depending on viscosity and consistency of the primer coating mixture, in a predetermined volatile solvent to the surface of the current collector 10. The primer coating mixture 20 may be delivered as a dry powder mixture in the case of spraying.

The primer coating mixture 20 may then optionally undergo any number of curing, drying, and/or insolubilization treatments to yield a dry primer-coated current collector 30.

Once the primer coating 20 is formed and dry, the resulting primer-coated current collector 30 may be sintered, pressed, or calendered to aid the binding of the primer coating 20 to the current collector 10. The term sintered is used herein to describe heating a material to above its melting point but to less than the decomposition temperature, and typically less than a temperature at which the viscosity of the material allows the material to flow like a liquid. Sintering of a fluororesin-containing primer coated current collector 30 is of particular importance when the fluororesin is mixed in the primer coating 20 in the form of a suspension (as opposed to a solution). Binder particles melt during the sintering process, thus improving the both the adhesion of the primer coating 20 to the current collector 10 and the impermeability of the coating 20 to water and electrolyte 50.

In some embodiments, the primer-coated current collector 30 of the present disclosure may be prepared in advance, stored and used on demand for the preparation of the positive electrode 1.

In some embodiments, the primer-coated current collector 30 may be prepared in line with the positive electrode 1, such as where a continuous fabrication process (aka roll-to-roll) is used.

Embodiments of the present disclosure relating to positive electrode composite layers (e.g. electrode composite layer 40 of FIG. 1) will now be further described.

As a result of a variety of extensive and intensive studies and experiments to solve the problem of electrolyte penetration and transport through thick porous electrodes, a positive electrode composite layer composition (e.g. electrode composite layer 40) including a hydrophilic binder has been discovered and has been confirmed to solve various problems encountered with electrode wettability in conventional positive electrode layers.

Any suitable material may be used as the positive electrode active material, without particular limitation, so long as the material reversibly stores zinc cations from a mild (pH ˜4 to ˜6) aqueous electrolyte (e.g. electrolyte 50) via any one or more of surface adsorption/desorption, pseudocapacitive reaction, intercalation/deintercalation, and conversion reactions. Examples of suitable electrode active material include manganese-based oxides (e.g. MnO₂ polymorphs), vanadium-based materials (e.g. V₂O₅ and derivatives), Prussian blue analogues (e.g. Zn₃[Fe(CN)₆]₂), Chevrel phases (e.g. ZnMo₆S₈), polyanionic compounds (e.g. Na₃V₂(PO₄)₂F₃), metal disulfides (e.g. VS₂) and organic compounds (e.g. calix [4]quinone). The present disclosure may be applied to any of the above listed materials, to any suitable material yet to discovered, and to any combinations thereof. Preferably, the positive electrode active material stores zinc at a potential ≥0.5 V vs Zn/Zn²⁺. When the potential of the positive electrode active material is too low, the aqueous rechargeable zinc-ion battery may not be able to deliver sufficient capacity and energy for application in large-scale energy storage systems.

The present disclosure may provide a positive electrode composition that allows high active material areal loading (20-50 mg·cm⁻²), mechanical integrity, and adhesion to a current collector (e.g. current collector 10) throughout the manufacturing, assembly and cycle-life of the aqueous rechargeable zinc battery. The positive electrode composition may further enable appropriate electrolyte transport through such thick (≥200 μm), albeit porous, electrode.

Generally, to achieve a combination of cohesive and adhesive strength, and appropriate electrolyte transport, the electrode composite layer 40 may include a hydrophilic binder. The hydrophilic binder may be substantially water-insoluble.

Suitable water-insoluble hydrophilic binders may include a polyvinyl butyral (PVB); a polyvinyl formal (PVF); a polyvinyl acetate (PVAc), but also a perfluorosulfonic acid (PFSA)-based polymer such as Nafion® and the like, a branched polyethylenimine (b-PEI), or a poly(4-vinylbenzoic acid) (P4VBA). Suitable water-insoluble hydrophilic binders are not limited to the foregoing.

In some cases, one or more water-soluble hydrophilic binders may be rendered insoluble in water, such as by way of curing and/or cross-linking. For example, chemical cross-linking of a polyvinyl alcohol (PVAOH) with boric acid, imidization of a polyamic acid to form a polyimide (PI), cross-linking of an alginate with Ca²⁺ or Zn²⁺, crosslinking of a polyacrylic acid (PAA) with a PVAOH, and curing of an alkoxysilyl group-containing resin such as those produced by Arakawa (“COMPOCERAN”) all result in water-insoluble binders suitable in a positive electrode of an aqueous rechargeable zinc battery as herein disclosed.

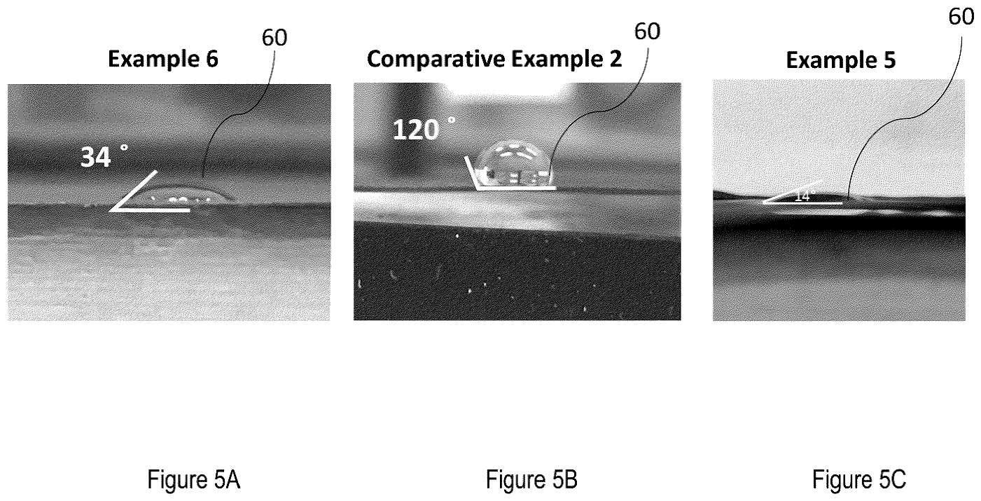

Referring now to FIGS. 5A, 5B, and 5C, shown therein are water contact angle experiments for the electrode of Example 6 (of Table 2, below), including a PVF binder in the composite layer 40, the electrode of Comparative Example 2 (of Table 2, below), including a PVDF binder, and the electrode of Example 5 (of Table 1, above). With the exception of the binder, Example 6 and Comparative Example 2 have identical compositions and were prepared according to the same slurry casting method.

FIGS. 5A and 5B depict wetting of PVDF versus PVF composite layers.

By using a hydrophilic binder in the electrode composite layer 40, wetting of the electrode microstructure by a mild (pH ˜4 to ˜6) aqueous electrolyte 50 may advantageously be achieved within minutes. In contrast, when a hydrophobic binder is used in the electrode composite layer, wetting requires extended time, increased temperature, vacuum, or a combination thereof.

While the PVF-based electrode composite 40 (Example 6) is hydrophilic as shown in FIG. 5A at 34° of a water drop 60, the PVDF-based electrode composite (Comparative Example 2) as shown in FIG. 5b is strongly hydrophobic at 120° of the water drop 60.

In FIG. 5C, a primer coating ink 20 was prepared by mixing 3 g of polyacrylic acid (PAA, Sigma Aldrich) and 3 g of sodium carboxymethyl cellulose (CMC, Sigma Aldrich) in 244 g of water at 80° C. using an overhead mixer until dissolved. To this binder solution, 7.2 g of hand sifted SuperC45 (Imerys Graphite & Carbon Switzerland SA), 240 mg of 50 wt % glutaraldehyde solution in water (Sigma Aldrich) and 1.8 g of Timrex BNB90 (Imerys Graphite & Carbon Switzerland SA) was dispersed using an overhead mixer and mixed for 3 hours. The ink 20 was filtered using an inline filter and peristaltic pump to remove large aggregates. The ink 20 is diluted with water until a viscosity of 0.8-1.0 dPas has been achieved.

FIG. 5C depicts the water droplet 60 on a hydrophilic primer layer.

A primed current collector 10 was prepared by applying the ink 20 onto a stainless steel current collector 10 using a spray gun. The ink 20 is cured in an 80° C. oven for 5 hours in air and the final primer coating 20 is 1-20 μm thick.

The resulting primer coating 20 was hydrophilic with a contact angle of 14° of the water drop 60.

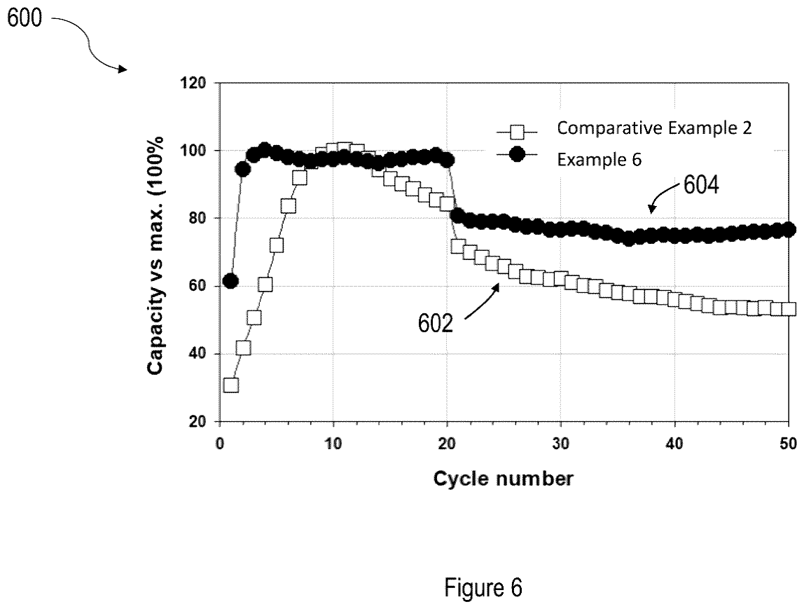

Referring now to FIG. 6, shown therein is is a graph 600 depicting the capacity over cycle number for aqueous rechargeable zinc batteries including either a positive electrode comprising an electrode composite layer 40 using a hydrophilic binder (Example 6) or a positive electrode comprising an electrode composite layer 40 using a hydrophobic binder (Comparative Example 2).

FIG. 6 depicts capacity retention of hydrophobic versus hydrophilic composite layers.

As can be seen in FIG. 6, the two electrodes exhibit strikingly different cycling behaviours when used in aqueous rechargeable zinc batteries.

In particular, the hydrophobic electrode is not fully wetted by the electrolyte 50 until the 10th cycle, resulting in a gradual capacity increase according to data 602.

In contrast, the hydrophilic electrode is wetted almost immediately, with the maximum of capacity observed at the 3rd discharge according to data 604.

After increasing the discharge current density in the 20th cycle, it appears that the hydrophilic electrode maintains more capacity than the hydrophobic electrode. This improved capacity retention may be because of facilitated transport of the electrolyte 50 throughout the porosity of the electrode film.

Although the case of a water-soluble hydrophilic binder such as a combination of carboxymethylcellulose (CMC) and styrene butadiene rubber (SBR) is not shown here, there has been observed rapid degradation in performance (capacity fading) when using such a binder in a positive electrode for a rechargeable zinc battery. Post-mortem analysis revealed the dissolution of the electrode film and complete loss of electrical contact with the current collector 10.

The positive electrode composite layer 40 may further include a conductive additive. The conductive additive may preferably be a carbon conductive additive. The conductive carbon additive may be one or more particulate additives, fibrous additives, or combinations thereof. Examples of particulate and fibrous carbon additives are provided above in the description of the primer coating.

In an embodiment, preferably, a combination of particulate carbon and fibrous carbon additives is used. Most preferably, the ratio of particulate carbon to total carbon conductive additive weight is between 70% and 99%. The content of conductive additive in the positive electrode composite layer depends on many different factors, including the particle size and particle size distribution of the active material, as well as intrinsic electronic conductivity, the chemical nature and molecular weight of the hydrophilic binder, the desired rate capability of the aqueous rechargeable battery, and the like. Without intending to be bound by any particular theory, it is believed that in order to achieve the desired level of electronic conductivity in the positive electrode composite layer 40, a carbon additive content of 0.1 to 25 wt % is preferred, and most preferably of 5 to 15 wt %.

In some embodiments, the electrode composite layer 40 may further include a plasticizer. The plasticizer may be used to provide improvements to the mechanical properties of the positive electrode 1. The plasticizer may be based on any one or more of oxalic acid, malonic acid, glutaric acid, succinic acid, adipic acid, pimelic acid, azelaic acid, sebacic acid, terephthalic acid, phthalic acid, isophthalic acid, and cyclohexane dicarboxylic acid.

In some embodiments, the positive electrode composite layer 40 may further include a gelling agent. The gelling agent may be used to improve interfacing with the electrolyte 50 and preventing dehydration of the electrode 1 throughout the cycle-life of the aqueous rechargeable zinc battery. Examples of the gelling agent suitable for the positive electrode composite layer 40 include a polyacrylic acid (PAA), a grafted starch material, a salt of a polyacrylic acid, a microcrystalline cellulose (MCC), a nanocrystalline cellulose (NCC), a carboxymethylcellulose (CMC), a salt of a carboxymethylcellulose (e.g., sodium carboxymethylcellulose), a gelatin, a carrageenan, a chitosan, a polyethylene oxide, a glyceryl monostearate, a polyvinyl pyrrolidone (PVP), a polyvinyl alcohol (PVAOH), a clay material such as montmorillonite or the like, and combinations thereof. In some embodiments, the positive electrode composite 40 may include, for example, between, between 0.05 wt % and 5 wt %, of gelling agent. In some embodiments, the positive electrode composite layer 40 may include, for example, between 0.1 wt % and 2 wt % of gelling agent.

Many different compositions for the positive electrode composite layer 40 were examined and some representative examples are listed in Table 2 below. Table 2 also summarizes the resistivity and hydrophilicity of each example.

TABLE 2
Resistivity and Hydrophilicity of Materials
of the Electrode Composite Layer

| | Volume | |
|---|---|---|
| Composition of the electrode | resistivity | Water contact- |
| composite layer | (Ω · cm) | angle (°) |
| Comparative Example 2. PVDF | 0.22 | 120 |
| Example 6. PVF | 0.24 | 34 |
| Example 7. PI | 1.2 | 18 |
| Example 8. PVF + 1.25 wt % NCC | 0.29 | 14 |

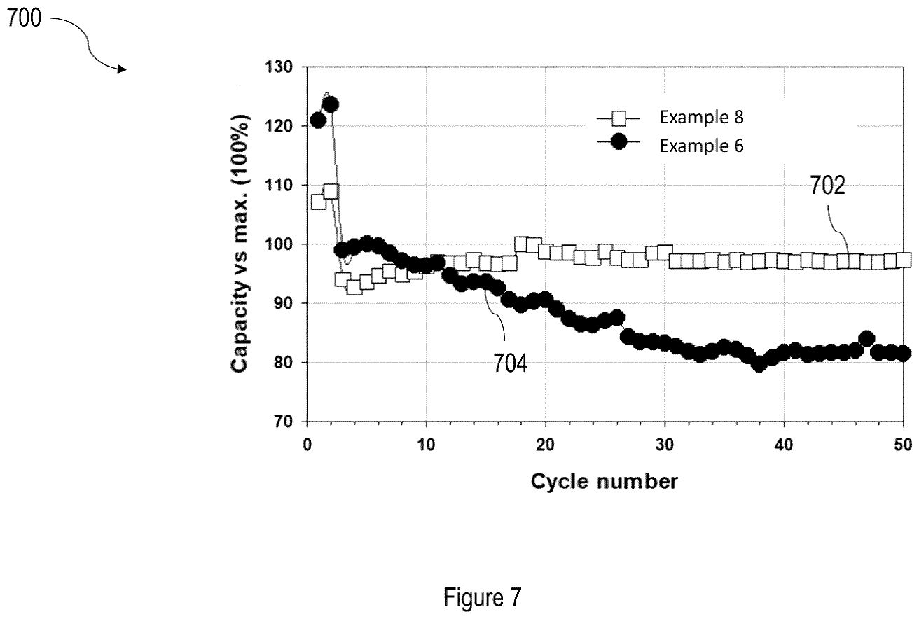

Referring now to FIG. 7, shown therein is a graph 700 depicting the capacity over cycle number for aqueous rechargeable zinc batteries including a positive electrode comprising a gelling agent as compared to a positive electrode without any electrolyte gelling agent.

The graph 700 compares the cycling behaviours when used in aqueous rechargeable zinc batteries using the electrode of Example 8, including 1.25% NCC in the composite layer 40 as data 702 and the electrode of Example 6, including no gelling agent in the composite layer 40 as data 704.

With the exception of the gelling agent, Example 8 and Example 6 have identical compositions and were prepared according to the same slurry casting method.

It is apparent from FIG. 7 that the electrode containing a gelling agent (Example 8) exhibits superior capacity retention over repeated cycling as compared to the electrode with no gelling agent (Example 6), owing to an improvement in the interface between the aqueous electrolyte 50 and the composite positive electrode 1.

FIG. 7 depicts capacity retention of the PVF composite layer including and not including NCC gel.

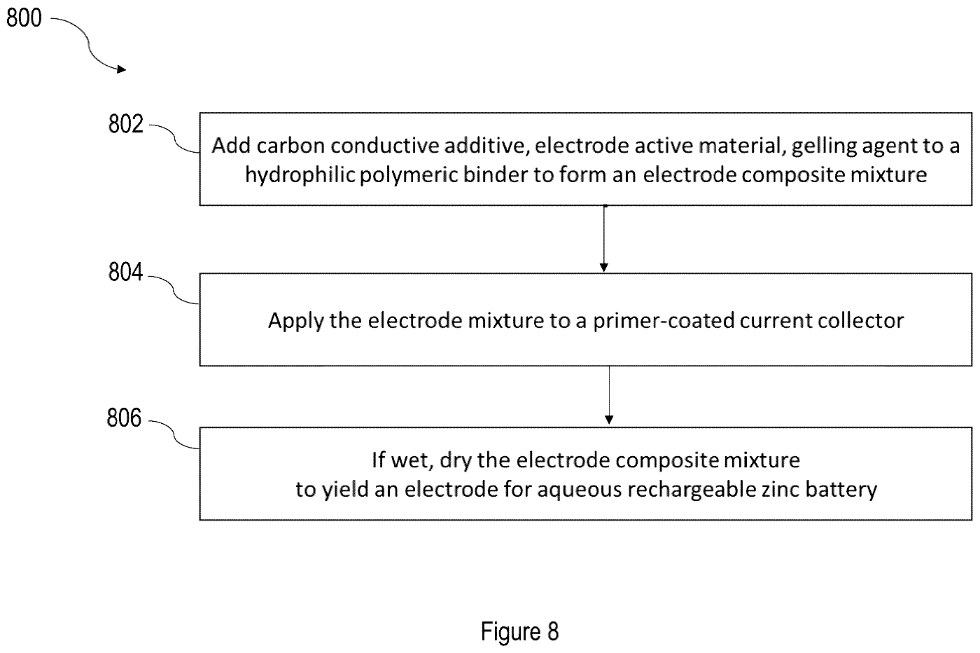

Referring now to FIG. 8, shown therein is a flow chart of a method 800 of preparing a positive electrode including an electrode composite layer having a hydrophilic binder, according to an embodiment The method 800 may be used, for example, to fabricate the positive electrode 1 of FIG. 1. While method 800 refers to the application of an electrode composite layer to a primer-coated current collector, it is to be understood that the method 800 may be similarly performed using a current collector that does not include a primer coating layer.

At 802, a carbon conductive additive, an electrode active material, and a gelling agent are added to a hydrophilic polymeric binder to form an electrode composite mixture.

At 804, the electrode composite mixture is applied to a primer-coated current collector (e.g. primer coated current collector 30 of FIG. 1). The primer-coated current collector 30 may be produced using the method 400 of FIG. 4.

Optionally, at 806, the electrode composite mixture 40 is dried if necessary to yield an electrode 1 for an aqueous rechargeable zinc battery. Step 806 may be used if the electrode composite mixture 40 is wet.

Each of 802, 804, and 806 are discussed in detail hereinbelow.

At 802, the components of the positive electrode composite layer 40 may be mixed using any suitable mixing method. The mixing method may be selected so as to obtain a desired dissolution, dispersion, or suspension of the solid components in a carrier solvent or solvents. The mixing method may be selected so as to obtain a dry mixture of the solid components. The mixing method may include, but is not limited to, one or more of mechanical agitation, grinding, ultrasonication, and ball milling.

The solvent may be acetone, N-methyl-2-pyrrolidone (NMP), methanol, dimethyl formamide (DMF) isopropanol, benzyl alcohol, diacetone alcohol, dioxane, acetophenone, water, mixtures, or solutions thereof, or any solvent that will serve to thoroughly mix the hydrophilic binder with the carbon conductive filler, active material and gelling agent for application to the current collector 30. Typically, the solvent is one that will dissolve the hydrophilic binder. The solvent may be selected based on the specific carbon filler used, the specific binder material selected, availability of materials, or preferences of the user.

The positive electrode composite layer 40 may be applied to the primer-coated current collector by, for example, tape casting, slot die coating, reverse roll coating, or spray-painting. The electrode composite mixture may be delivered as a slurry, paste, or ink (depending on the viscosity and consistency) in a predetermined volatile solvent to one or more surfaces of the current collector 10. The electrode composite mixture may also be delivered as a dry powder mixture in the case of spraying.

The positive electrode composite layer 40 may optionally undergo any number of curing, drying, and/or insolubilization treatments to yield a dry positive electrode 1.

Once the electrode composite layer 40 is formed and dry, the resulting positive electrode 1 may be sintered, pressed, or calendered to aid the binding of the electrode composite layer 40 to the primer-coated current collector 30. The term sintered is used herein to describe heating a material to above its melting point but to less than the decomposition temperature, and typically less than a temperature at which the viscosity of the material allows the material to flow like a liquid.

The electrode composite layer 40 may be applied on one or both surfaces of the primer-coated current collector 30. Preferably, the electrode composite layer 40 is applied on both surfaces of the current collector.

Embodiments of positive electrodes for aqueous rechargeable zinc batteries will now be further described.

FIG. 8 shows a flow chart for composite layer preparation.

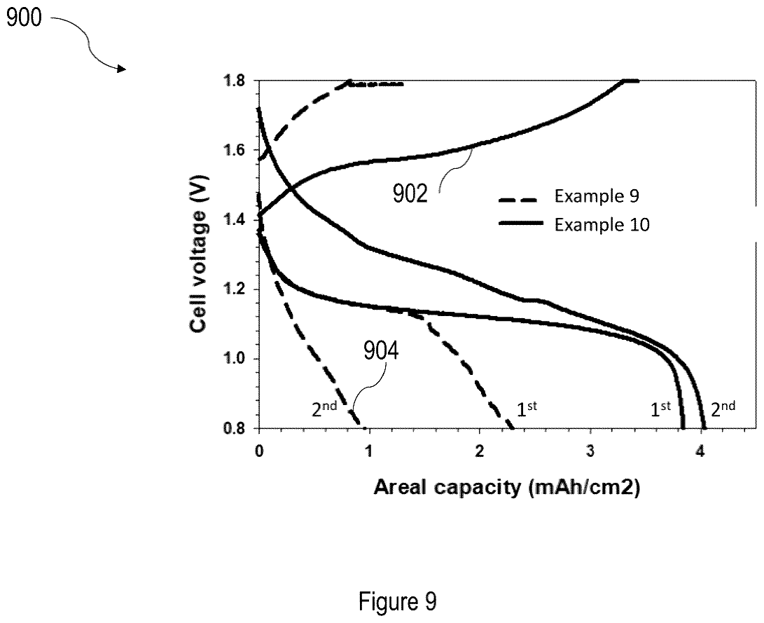

Referring now to FIG. 9, shown therein is a graph 900 depicting first and second cycles of aqueous rechargeable batteries using a positive electrode, such as positive electrode 1 of FIG. 1, according to embodiments.

The aqueous rechargeable batteries using a positive electrode whose cycles are depicted include a positive electrode having a primer coating 20 in between a current collector 10 and an electrode composite layer 40 (Example 10) as data 902, as compared to a positive electrode with no primer coating 20 and an electrode composite layer 40 applied to a current collector 10 (Example 9) as data 904.

As described in the foregoing method, a positive electrode 1 for aqueous rechargeable zinc battery may be fabricated by applying an electrode composite layer 40 as described above onto a primer-coated current collector 30 as described above. This multilayer architecture including the primer layer 20 (Example 10) was found to be preferable to applying an electrode composite layer 40 directly onto the bare current collector 10 (Example 9). In particular, the primer coating 20 may promote adhesion of the electrode composite layer 40 to the current collector 30 while imparting corrosion resistance to the current collector 30 during the repeated charges and discharges of an aqueous rechargeable zinc battery.

These results can be observed in FIG. 9, where the electrode composite layer 40 has been either applied directly to a stainless-steel foil current collector 10 (Example 9) or on a primer-coated stainless-steel foil current collector 30 (Example 10). It is apparent in graph 900 that the electrode with no primer coating (Example 9) cannot be recharged and cycled repeatedly. A post-mortem analysis of this electrode revealed that the current collector 10 was severely passivated. Furthermore, the electrode composite layer 40 delaminated from the current collector 10.

In contrast, it is apparent from graph 900 that the positive electrode of Example 10 can be recharged and discharged repeatedly, without significant increase in internal resistance.

FIG. 9 depicts voltage profiles for the hydrophilic composite layer on primer coated and bare stainless steel.

Exemplary electrochemical devices in which the positive electrodes of the present disclosure may be used have at least a positive electrode; a negative electrode; and an aqueous electrolyte. The aqueous electrolyte may be any mildly acidic (pH ˜4 to ˜6) electrolyte that includes a zinc salt, such as zinc sulfate. In some embodiments, the electrochemical device is a zinc rechargeable battery. In embodiments, the positive electrode has a composition and architecture as described herein, such as including a primer coating layer (e.g. primer layer 20), an electrode composite layer (e.g. electrode composite layer 40) having a hydrophilic binder, or including both a primer coating layer and an electrode composite layer having a hydrophilic binder. The negative electrode may be zinc, a zinc alloy, or mixtures of any two or more such materials. Also, typically in an electrochemical device, the negative and positive electrodes are separated from each other by a porous separator.

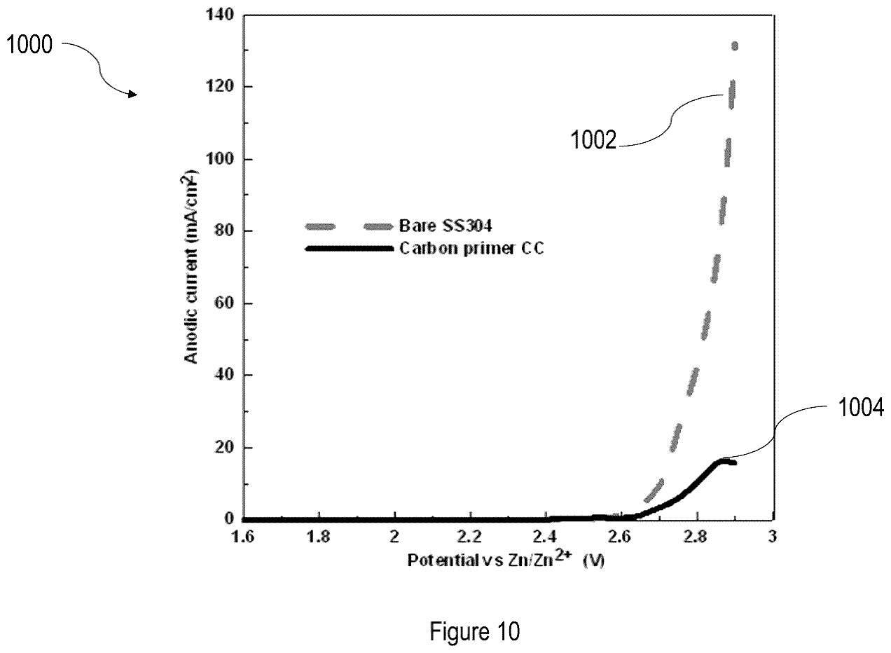

Referring now to FIG. 10, shown therein is a graph 1000 depicting anodic stability of uncoated stainless steel and primer-coated stainless steel using linear sweep voltammetry at a scan rate of 0.1 mV/s in 1 M ZnSO₄+0.2 M MnSO₄.

In the graph 1000, data 1002 depict anodic stability of the uncoated stainless steel.

In the graph 1000, data 1004 depict anodic stability of the primer-coated stainless steel.

FIG. 10 depicts the anodic stability of primer layers.

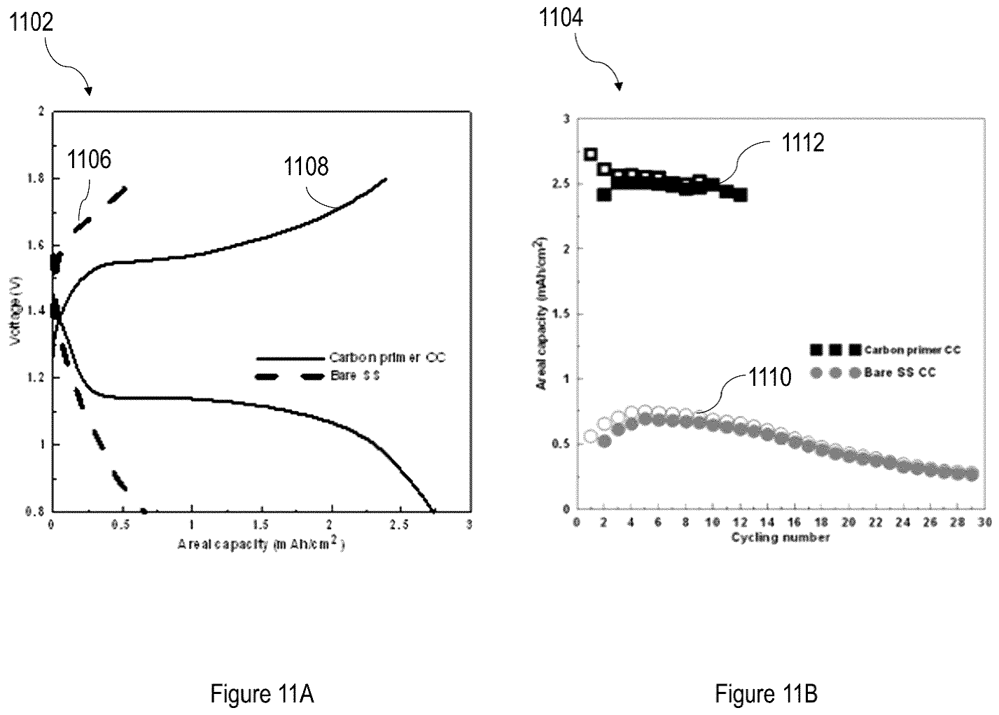

Referring now to FIG. 11A, shown therein is a graph 1102 depicting voltage profiles 1106 and 1008 for the first cycle of cells using zinc negative electrodes and a PVF-based positive electrode coating on a bare stainless steel current collector 10 and primer-coated stainless steel current collector 30, respectively. These cells were cycled with 1 M ZnSO₄ electrolyte at a C/3 rate between 0.8 V and 1.8 V.

Referring now to FIG. 11B, shown therein is a graph 1102 of capacity retention of the cells of FIG. 11A. Data 1110 depicts the capacity retention of the bare stainless steel current collector 10. Data 1112 depicts the capacity retention of the primer-coated stainless steel current collector 30.

FIGS. 11A and 11B depict voltage profiles and capacity retention of a hydrophilic composite layer on primer-coated and bare stainless steel.

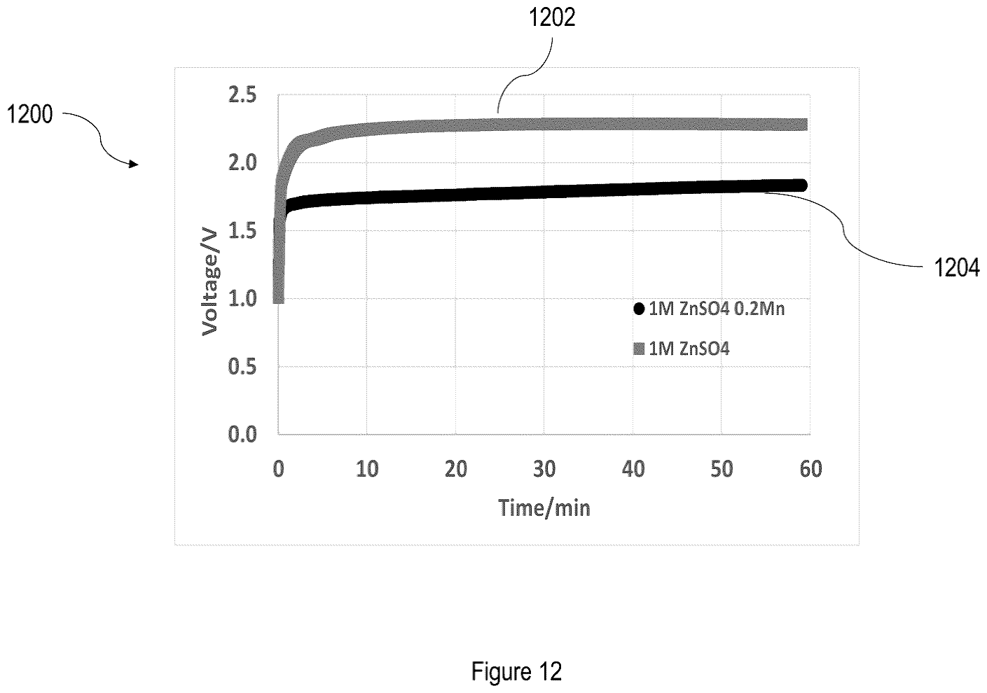

Referring now to FIG. 12, shown therein is a graph 1200 depicting chronopotentiometry of a primer-coated stainless steel current collector 30 at 0.2 mA/cm² in 1 M ZnSO₄ and 1 M ZnSO₄+0.2 M MnSO₄ electrolytes as data 1202 and 1204, respectively. The presence of Mn²⁺ in the electrolyte 50 may lead to plating of MnO₂ at a voltage less than 1.8 V (used as the charge cut-off voltage in zinc-ion cells).

FIG. 12 depicts chronopotentiometry of primer layers including and not including Mn2+ in the electrolyte 50.

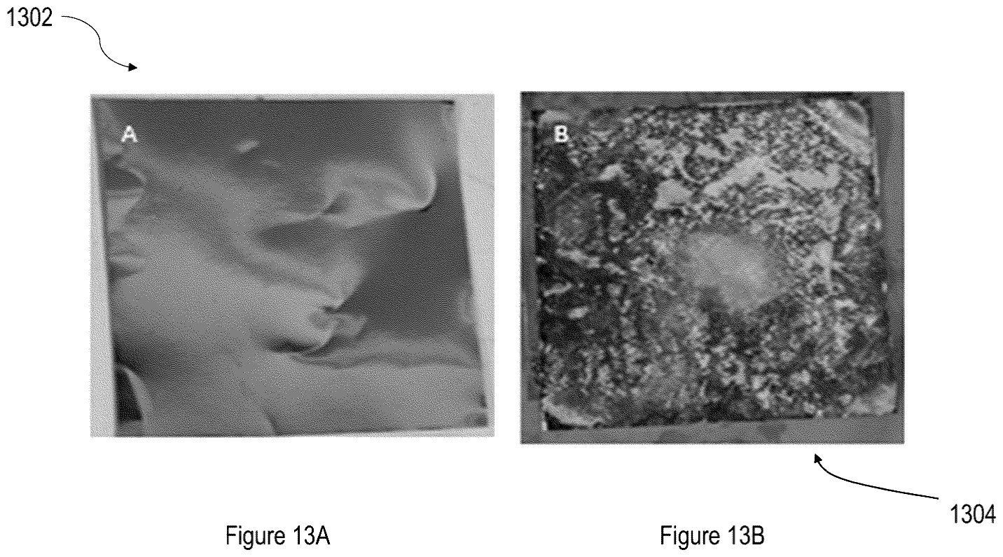

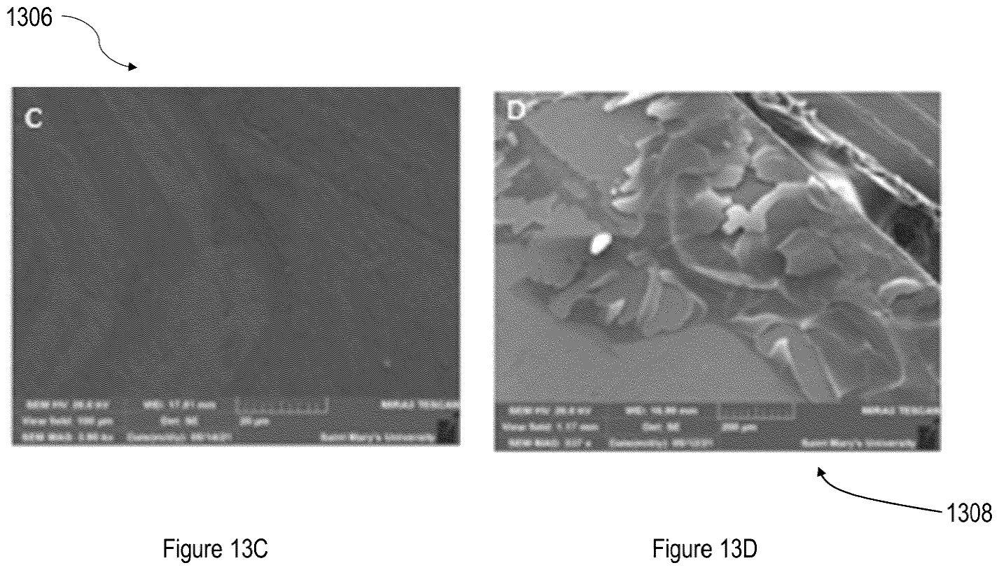

Referring now to FIG. 13A, shown therein is an optical image of pristine stainless steel 1302.

Referring now to FIG. 13B, shown therein is an optical image of stainless steel 1304 after plating MnO₂ at 1.8 V.

Referring now to FIG. 13C, shown therein is a SEM image of pristine stainless steel 1306.

Referring now to FIG. 13D, shown therein is a SEM image of stainless steel 1308 after plating MnO2 at 1.8 V.

FIG. 13 depicts images of bare stainless steel and stainless steel passivated with MNO₂.

In Table 3 below, there are shown through plane resistance values for a pristine stainless steel current collector 10 and a primer-coated stainless steel current collector 30 before and after plating MnO₂ on the surface thereof.

TABLE 3
Through Plane Resistance

| Sample | Through Plane Resistance (Ohms) |
|---|---|
| Pristine SS | 0.27 |
| Pristine Primed SS | 0.32 |
| Mn Plated SS | 120 |
| M Plated Primed SS | 3.8 |

In preparing for testing the MnO2 plating hereinbefore described, the following process was employed:

A cell was made using a zinc negative electrode (5 cm×5 cm), a separator with ˜3 mL of electrolyte 50, and a positive current collector (4 cm×4 cm) 10. The separator used was a polyethylene/SiO2 composite membrane (Entek International). The electrolyte 50 was 1M ZnSO₄+0.2M MnSO₄ dissolved in water. The cell was rested for 5 hours and then held at 1.8 V for 20 hours.

In preparing for testing the positive electrode hereinbefore described, the following process was employed:

An electrode slurry 40 was prepared by dissolving 70 g of 36K polyvinyl formal (PVF, Suketu Organics) and 70 g of 108K PVF (Suketu Organics) in 2150 g of acetophenone (Vigon International Inc.) using a vacuum mixer without vacuum at 100 rpm. Once dissolved, vacuum was applied to −1 bar for ˜20 mins with mixer set to 100 rpm. To this solution, 20 g of adipic acid (Univar Solutions), 20 g of benzoic acid (Univar Solutions), and 40 g of proviplast 01422 (Proviron) was dissolved into the mixture in the vacuum mixer until dissolved under vacuum. Once dissolved, 80 g of Timrex BNB90 (Imreys Imerys Graphite & Carbon Switzerland SA) and 266.7 g of Vulcan XC72R (Cabot Corp) was dispersed into the mixture mixed for an hour under vacuum. Once the carbons were dispersed, a dry mixed powder of 2900 g EMD10 (Borman Specialty Materials), 133.3 g Vulcan XC72R (Cabot Corp.), and 400 g of nanocrystalline cellulose (Celluforce) was dry mixed and sieved using No. 140 mesh sieve. The premixed and sieved dry powders were added to the slurry mixture in the vacuum mixer and mixed overnight under vacuum at 300 rpm.

A positive electrode 1 was prepared by casting the slurry 40 prepared above onto the current collector. After casting, the electrode 1 was dried at 48C in air.

The anodic stability test on carbon prime ss was conducted as follows:

The linear sweep voltammetry was done in the three electrode Swagelok cell format including the carbon prime SS as the working electrode, zinc as both the counter and reference electrode. The scanning rate was 0.1 mV/s to 3 V. The chronopotentiometry tests in this study were conducted on the carbon prime SS in two electrolytes as 1 M ZnSO₄ and 1 M ZnSO₄+0.2 MnSO₄. The applied current density was 0.1 mA/cm² for the first cell and 0.2 mA/cm² for the second cell. The cycling performance of positive electrodes on SS was measured with and without carbon primer: The cycling protocol is a constant current cycling at C/3 between 0.8 V to 1.8 V, and extra CV steps where the voltage was holding at 1.8V until the current decrease by 30%.

Further suitable binders include Polyvinyl butyral (PVB), polyvinyl formal (PVF), polyvinyl acetate (PVAc), polyvinyl alcohol (PVA), polyacrylic acid (PAA), carboxymethyl cellulose (CMC), polyvinyl chloride (PVC), polyethylene oxide (PEO), polyvinyl pyrrolidone (PVP), chitosan, alginate, polyimide (P1), polyurethane (PU), guar gum, agar, gelatin, xanthan gum, gum arabic, perfluorosulfonic acid (PFSA)-based polymer, polyethylenimine (PEI), or poly(4-vinylbenzoic acid) (P4VBA).

The following paragraphs describe the experimental methods used herein.

### COMPARATIVE EXAMPLE 1

A grade 304 stainless steel foil (26 μm thick, All foils) was used as received. Comparative Example 1 is uncoated, bare, no primer stainless steel.

### EXAMPLE 1

A primer coating ink 20 was prepared by mixing 7 g Super C45 carbon to a solution of Kynar Flex LBG 8200 (3 g) in acetone (90 g) via ultrasonication. The ink 20 was spray-coated onto the stainless-steel foil of Comparative Example 1, air-dried at room temperature, and the primer-coated current collector 30 was then annealed at 200° C. for 1 hour in a convection oven. The final coating thickness was approx. 20 μm. Example 1 is primer coated stainless steel with PVDF binder.

### EXAMPLE 2

A primer coating ink 20 was prepared by mixing 5 g Super C45 carbon and 1 g carboxymethyl cellulose (CMC) to a suspension of Lumiflon FE-4300 (20 g at 50 wt % solids) and then diluted to 100 g with 50 g isopropyl alcohol and 34 g water via ultrasonication. The ink 20 was spray-coated onto the stainless-steel foil of Comparative Example 1, air-dried at room temperature, and the primer-coated current collector 30 was then annealed at 200° C. for 1 hour in a convection oven. The final coating thickness was approx. 20 μm. Example 2 is primer coated stainless steel with Lumiflon binder

### EXAMPLE 3

A primer coating ink 20 was prepared by mixing 50 g of the primer coating 20 of Example 2 with 25 g Bonderite S-FN EB 012 and then diluted to 100 g with 20 g isopropyl alcohol. The ink 20 was spray-coated onto the stainless-steel foil of Comparative Example 1, air-dried at room temperature, and the primer-coated current collector 30 was then annealed at 200° C. for 1 hour in a convection oven. The final coating thickness was approx. 20 μm. Example 3 is primer coated stainless steel with Bonderite and Lumiflon binders.

### EXAMPLE 4

A primer coating ink 20 was prepared by diluting 50 g Bonderite EB-12 to 100 g with 50 g isopropyl alcohol. The ink 20 was spray-coated onto the stainless-steel foil of Comparative Example 1, air-dried at room temperature, and the primer-coated current collector 30 was then dried at 80° C. for 1 hour in a convection oven. The final coating thickness was approx. 20 μm. Example 4 is primer coated stainless steel with bonderite binder.

### EXAMPLE 5

Primer coated stainless steel with PAA/CMC crosslinked binders.

### COMPARATIVE EXAMPLE 2

A positive electrode 1 was prepared by casting a slurry 40 of electrolytic manganese dioxide (EMD, Tronox), Vulcan XC72 carbon black (Cabot Corp.), and polyvinylidene fluoride (PVDF) binder (HSV1800, Arkema) in N-methyl-2-pyrrolidone (NMP) solvent in the weight ratio of 87:10:3 onto a graphite foil current collector 10. After casting, the electrode 1 was dried at 120° C. under partial vacuum for 2 hours. Comparative Example 2 is hydrophobic composite layer with PVDF binder on graphite foil (no primer layer—not required for carbon current collectors).

### EXAMPLE 6

A positive electrode 1 was prepared by casting a slurry 40 of electrolytic manganese dioxide (EMD, Tronox), Vulcan XC72 carbon black (Cabot Corp.), and polyvinyl formal (PVF) binder (Suketu Organics) in acetophenone solvent in the weight ratio of 87:10:3 onto a graphite foil current collector 10. After casting, the electrode 1 was dried at 80° C. in air for 12 hours. Example 6 is hydrophilic composite layer with PVF binder on graphite foil (no primer layer—not required for carbon current collectors).

### EXAMPLE 7

A polyamide binder was prepared by mixing 4,4′-oxydianiline and benzophenone-3,3′,4,4′-tetracarboxylic dianhydride in N-methyl-2-pyrrolidone (NMP) solvent. A condensation reaction occurred to form poly(amic acid). A positive electrode 1 was prepared by casting a slurry 40 of electrolytic manganese dioxide (EMD, Tronox), Vulcan XC72 carbon black (Cabot Corp.), and the polyamide binder in the weight ratio of 87:10:3 onto a graphite foil current collector 10. After casting, the electrode 1 was dried at 80° C. in air for 12 hours. The electrode 1 was further annealed in air at 250° C. for 1 hour for the imidization reaction to take place where poly(amic acid) is converted to polyimide at the high temperature. Example 7 is hydrophilic composite layer with PI binder on graphite foil (no primer layer—not required for carbon current collectors)

### EXAMPLE 8

A positive electrode 1 was prepared by casting a slurry 40 of electrolytic manganese dioxide (EMD, Tronox), Vulcan XC72 carbon black (Cabot Corp.), Nano Crystalline Cellulose powder (NCC, Celluforce), and polyvinyl formal (PVF) binder (xxx) in acetophenone solvent in the weight ratio of 85.5:10:1.25:3 onto a graphite foil current collector 10. After casting, the electrode 1 was dried at 80° C. in air for 12 hours. Example 8 is hydrophilic composite layer with PVF binder and NCC gel on graphite foil (no primer layer—not required for carbon current collectors).

### EXAMPLE 9

The positive electrode composite slurry 40 of Example 8 was casted onto a stainless-steel current collector 10. After casting, the electrode 1 was dried at 80° C. in air for 12 hours. Example 9 is hydrophilic composite layer with PVF binder and NCC gel on bare stainless steel foil.

### EXAMPLE 10

The positive electrode composite slurry 40 of Example 8 was casted onto the primer-coated current collector 30 of Example 1. After casting, the electrode 1 was dried at 80° C. in air for 12 hours. Example 10 is hydrophilic composite layer with PVF binder and NCC gel on primer coated stainless steel foil with PVDF binder (from Example 1).

### COMPARATIVE EXAMPLE 3

Hydrophilic composite layer with PVF binder and 10% NCC gel (different formulation than Examples 8-10) on bare stainless steel foil (no primer layer).

### EXAMPLE 11

Hydrophilic composite layer with PVF binder and 10% NCC gel (different formulation than Examples 8-10) on primer coated stainless steel foil with PAA/CMC crosslinked binders.

All electrochemical cells (used in the graphs 300, 600, 700, and 900 of FIGS. 3, 6, 7, 9, respectively) were assembled using a homemade plate design including a rubber gasket sandwiched between two acrylic plates The acrylic plates were bolted together and housed the electrode stack (negative/separator/positive). The electrode stack was compressed together between Ti plates by external screws which also served as electrical connections.

The aqueous rechargeable zinc batteries (e.g., zinc ion cells used in the graphs 600, 700, and 900 of FIGS. 6, 7, 9, respectively) were assembled using a zinc negative electrode, 5.5 cm×5.5 cm), a separator with ˜3 mL of electrolyte 50, and a positive electrode (5 cm×5 cm) 1. The zinc negative electrode was a piece of zinc foil (30 μm thick, Linyi Gelon LIB Co., Ltd.). The separator used was glass fiber filter membrane (˜300 μm thick). The electrolyte 50 was 1 M ZnSO₄ dissolved in water for all cells. The cells were cycled galvanostatically at 1.0 mA/cm² at room temperature (23±2° C.) between 0.8 V an 1.8 V. For the linear sweep voltammetry experiments (measured in the graph 300 of FIG. 3), the cells were assembled identically, using a current collector as the positive electrode 1, and charged at a rate of 0.1 mV/s up to 3.0V.

While the above description provides examples of one or more apparatus, methods, or systems, it will be appreciated that other apparatus, methods, or systems may be within the scope of the claims as interpreted by one of skill in the art.

1-189. (canceled)

190. A rechargeable battery comprising:
a zinc metal negative electrode;
an electrolyte having a pH between 3.5 and 6.5, wherein the electrolyte comprises water and at least one type of zinc salt; and
a positive electrode comprising:
a current collector comprising an active material;
a primer coating layer applied to the current collector, the primer coating layer comprising binder and conductive particles;
wherein the active material in the positive electrode undergoes reversible electrochemical reactions with Zn²⁺ cations during normal operation.

191. The battery of claim 190, wherein the binder of the primer coating layer is hydrophobic.

192. The battery of claim 190, wherein the binder of the primer coating layer is hydrophilic.

193. The battery of claim 190, wherein the primer coating layer provides a network of porous structures to increase available surface area of the current collector.

194. The battery of claim 190, wherein the primer coating layer has a thickness of about 1 μm to 20 μm.

195. The battery of claim 190, wherein a surface of the primer-coated current collector exposed to the electrolyte is hydrophobic.

196. The battery of claim 190, wherein the conductive particles of the primer coating layer comprise electrically conductive carbon.

197. The battery of claim 196, wherein electrically conductive carbon comprises at least one of spherical particles and fibrous particles.

198. The battery of claim 190, wherein the positive electrode composite layer further comprises a plasticizer.

199. The battery of claim 198, wherein the plasticizer is any one or more of oxalic acid, malonic acid, glutaric acid, succinic acid, adipic acid, pimelic acid, azelaic acid, sebacic acid, terephthalic acid, phthalic acid, isophthalic acid, or cyclohexane dicarboxylic acid.

200. The battery of claim 190, wherein the binder in the positive electrode coating layer is hydrophilic.

201. The battery of claim 190, wherein the positive electrode composite layer further comprises a gelling agent.

202. The battery of claim 201, wherein the gelling agent comprises any one or more of a polyacrylic acid, a grafted starch material, a salt of a polyacrylic acid, a microcrystalline cellulose, a nanocrystalline cellulose, a carboxymethylcellulose, a salt of a carboxymethylcellulose, a gelatin, a carrageenan, a chitosan, a polyethylene oxide, a glyceryl monostearate, a polyvinyl pyrrolidone, a polyvinyl alcohol, and a clay material.

203. A method for manufacturing a primer coated current collector for use in a positive electrode in an aqueous zinc rechargeable battery, comprising:
forming a primer mixture comprising conductive filler, binder, and solvent; and
applying the primer mixture to the current collector to form the primer-coated current collector.

204. The method of claim 203, further comprising:
forming an electrode composite mixture comprising binder, conductive additive, active material, and solvent; and
applying the electrode composite mixture to a primer-coated current collector.

205. The method of claim 203, wherein the solvent comprises any one or more of acetone, N-methyl-2-pyrrolidone (NMP), methanol, dimethyl formamide (DMF) isopropanol, benzyl alcohol, diacetone alcohol, dioxane, acetophenone, and mixtures or solutions thereof.

206. The method of claim 203, wherein the solvent is water and the binder is made insoluble in water through cross-linking.

207. The method of claim 204, wherein the solvent comprises any one or more of acetone, N-methyl-2-pyrrolidone (NMP), methanol, dimethyl formamide (DMF) isopropanol, benzyl alcohol, diacetone alcohol, dioxane, acetophenone, and mixtures or solutions thereof.

208. The method of claim 204, wherein the solvent is water and the binder is made insoluble in water through cross-linking.
